(19) United States
(12) Patent Application Publication
(10) Pub. No.: US 2022/0294007 A1
(43) Pub. Date: Sep. 15, 2022

(54) SOLID ELECTROLYTE, SOLID ELECTROLYTE LAYER, AND SOLID ELECTROLYTE BATTERY

(71) Applicant: TDK CORPORATION, Tokyo (JP)

(72) Inventors: Tetsuya UENO, Tokyo (JP); Hisashi SUZUKI, Tokyo (JP)

(73) Assignee: TDK CORPORATION, Tokyo (JP)

(21) Appl. No.: 17/632,388

(22) PCT Filed: Jul. 29, 2020
(86) PCT No.: PCT/JP2020/029019

§ 371 Date: Feb. 2, 2022

(30) Foreign Application Priority Data
Aug. 7, 2019 (JP) 2019-145663

(51) Int. Cl. H01M 10/0562; H01M 10/0525

(52) U.S. Cl. CPC H01M 10/0562; H01M 10/0525; H01M 2300/008

(57) ABSTRACT

A solid electrolyte contains a compound that contains an alkali metal element, a tetravalent metal element, and a halogen element as main elements, in which the compound has diffraction peaks at positions of 2θ=32.0°±0.5° and 2θ=34.4°±0.5° for a wavelength of CuKα rays, and a ratio IB/IA of a diffraction intensity IB of a peak with a strongest diffraction intensity at 2θ=34.4°±0.5° to a diffraction intensity IA of a peak with a strongest diffraction intensity at 2θ=32.0°±0.5° satisfies 0<IB/IA≤3.

### TECHNICAL FIELD

The present invention relates to a solid electrolyte, a solid electrolyte layer, and a solid electrolyte battery. Priority is claimed on Japanese Patent Application No. 2019-145663, filed Aug. 7, 2019, the content of which is incorporated herein by reference.

### BACKGROUND ART

In recent years, the development of electronics technology has been remarkable, and portable electronic apparatuses have been made smaller and lighter, thinner, and more multifunctional. Along with this, there is a strong demand for batteries that serve as power sources for electronic apparatuses to be smaller and lighter, thinner, and more reliable, and solid electrolyte batteries that use solid electrolytes as electrolytes are attracting attention.

As an example of a method for producing a solid electrolyte battery, there are a sintering method and a powder forming method. In the sintering method, a negative electrode, a solid electrolyte layer, and a positive electrode are laminated and thereafter sintered to form a solid electrolyte battery. In the powder forming method, a negative electrode, a solid electrolyte layer, and a positive electrode are laminated, and thereafter, pressure is applied to form a solid electrolyte battery. Materials that can be used for the solid electrolyte layer differ depending on the production method. As the solid electrolyte, an oxide-based solid electrolyte, a sulfide-based solid electrolyte, a complex hydride-based solid electrolyte (such as LiBH₄) and the like are known.

Patent Document 1 discloses a solid electrolyte secondary battery including a positive electrode, a negative electrode, and a solid electrolyte composed of a compound represented by the general formula Li_{3-2X}M_{X}In_{1-Y}M′_{Y}L′_{Z}. In the above-mentioned general formula, M and M′ are metal elements, and L and L′ are halogen elements. Furthermore, X, Y, and Z independently satisfy 0≤X<1.5, 0≤Y<1, and 0≤Z≤6. Furthermore, the positive electrode includes a positive electrode layer containing a positive electrode active material including elemental Li, and a positive electrode current collector. Furthermore, the negative electrode includes a negative electrode layer containing a negative electrode active material, and a negative electrode current collector.

Patent Document 2 discloses a solid electrolyte material represented by Composition Formula (1) below:

Li_{6-3Z}Y_{Z}X₆ Formula (1)

provided that 0<Z<2 is satisfied, and X is Cl or Br.

Furthermore, Patent Document 2 discloses a battery in which at least one of a negative electrode and a positive electrode contains the above-mentioned solid electrolyte material.

Patent Document 3 discloses an all-solid-state battery including an electrode active material layer containing a first solid electrolyte material and a second solid electrolyte material. The first solid electrolyte material is a single-phase electron-ion mixed conductor and is a material containing an active material, and an anionic component that comes into contact with the active material and is different from an anionic component of the active material. The second solid electrolyte material is an ion conductor that comes into contact with the first solid electrolyte material, has the same anionic component as that of the first solid electrolyte material, and does not have electron conductivity. In addition, the first solid electrolyte material is Li₂ZrS₃ and has peaks at the position of 2θ=34.2°±0.5° and the position of 2θ=31.4°±0.5° in X-ray diffraction measurement using CuKα rays. When the diffraction intensity of the peak of Li₂ZrS₃ at 2θ=34.2°±0.5° of the first solid electrolyte material is IA, and the diffraction intensity of the peak of ZrO₂ at 2θ=31.4°±0.5° is IB, a value of IB/IA is 0.1 or less.

### CITATION LIST

### Patent Literature

[Patent Document 1]

Japanese Unexamined Patent Application, First Publication No. 2006-244734
[Patent Document 2]

PCT International Publication No. WO2018/025582
[Patent Document 3]

Japanese Unexamined Patent Application, First Publication No. 2013-257992

### SUMMARY OF INVENTION

### Technical Problem

However, it cannot be said that any of the solid electrolytes disclosed in Patent Document 1 to Patent Document 3 has sufficient ion conductivity. Therefore, a sufficient discharge capacity could not be obtained in conventional solid electrolyte batteries.

The present invention has been made in view of the above-mentioned problems, and an object of the present invention is to provide a solid electrolyte, a solid electrolyte layer, and a solid electrolyte battery using the same, which have improved ion conductivity.

### Solution to Problem

The inventors of the present invention have made extensive studies to achieve the above-mentioned object.

As a result, they have found that the ion conductivity of movable ions is high in a solid electrolyte which contains, as a main element, a compound containing an alkali metal element, a tetravalent metal element, and a halogen element and in which a characteristic structure is confirmed in measurement results of X-ray diffraction (XRD).

That is, the following means are provided to achieve the above-mentioned object.

(1) A solid electrolyte according to a first aspect contains, as a main element, a compound that contains an alkali metal element, a tetravalent metal element, and a halogen element, in which the compound has diffraction peaks at positions of 2θ=32.0°±0.5° and 2θ=34.4°±0.5° for a wavelength of CuKα rays, and a ratio IB/IA of a diffraction intensity IB of a peak with a strongest diffraction intensity at 2θ=34.4°±0.5° to a diffraction intensity IA of a peak with a strongest diffraction intensity at 2θ=32.0°±0.5° satisfies 0<IB/IA≤3.

(2) A solid electrolyte according to a second aspect contains a compound that contains an alkali metal element, a tetravalent metal element, and a halogen element as main elements, in which the compound has diffraction peaks at positions of 2θ=32.0°±0.5° and 2θ=30.0°±0.5° for a wavelength of CuKα rays, and a ratio IC/IA of a diffraction intensity IC of a peak with a strongest diffraction intensity at 2θ=30.0°±0.5° to a diffraction intensity IA of a peak with a strongest diffraction intensity at 2θ=32.0°±0.5° satisfies 0<IC/IA≤2.

(3) The compound of the solid electrolyte according to the above-mentioned aspects may have a diffraction peak at each of positions of 2θ=16.1°±0.5°, 2θ=41.7°±0.5°, and 2θ=49.9°±0.5° for the wavelength of CuKα rays.

(4) The compound of the solid electrolyte according to the above-mentioned aspects may have a diffraction peak at each of positions of 2θ=43.7°±0.5°, 2θ=45.0°±0.5°, 2θ=54.2°±0.5°, 2θ=59.1°±0.5°, 2θ=60.5°±0.5°, and 2θ=62.2°±0.5° for the wavelength of CuKα rays.

(5) The compound of the solid electrolyte according to the above-mentioned aspects may have a diffraction peak at each of positions of θ=30.0°±0.5° and 2θ=34.4°±0.5° for the wavelength of CuKα rays.

(6) The solid electrolyte according to the above-mentioned aspects, in which the tetravalent metal element is one or more elements selected from the group consisting of Zr, Hf, Ti, Sn, and Ge.

(7) The solid electrolyte according to the above-mentioned aspects, in which the compound is represented by the composition formula Li₂₊ₐM_{b}Zr_{1+c}Cl_{6+d}, −1.5≤a≤1.5, 0≤b≤1.5, −0.7≤c≤0.2, and −0.2≤d≤0.2 is satisfied, and M is one or more elements selected from Al, Y, Ca, Nb, and Mg.

(8) A solid electrolyte layer according to a third aspect contains the solid electrolyte according to the above-mentioned aspects.

(9) A solid electrolyte battery according to a fourth aspect includes a positive electrode; a negative electrode; and a solid electrolyte layer sandwiched between the positive electrode and the negative electrode, in which at least one of the positive electrode, the negative electrode, and the solid electrolyte layer contains the solid electrolyte according to the above-mentioned aspects.

(10) A solid electrolyte battery according to a fifth aspect includes a positive electrode; a negative electrode; and a solid electrolyte layer sandwiched between the positive electrode and the negative electrode, in which the solid electrolyte layer contains the solid electrolyte according to the above-mentioned aspects.

### Advantageous Effects of Invention

The solid electrolyte, the solid electrolyte layer, and the solid electrolyte battery according to the above-mentioned aspects have high ion conductivity.

### BRIEF DESCRIPTION OF DRAWINGS

FIG. 1 is a schematic cross-sectional view of a solid electrolyte battery according to the present embodiment.

FIG. 2 shows background X-ray diffraction results.

FIG. 3 shows X-ray diffraction results of solid electrolytes according to Example 1, Example 9, Example 10, and Comparative Example 2.

FIG. 4 is an enlarged view of a main part of the X-ray diffraction results of the solid electrolytes according to Example 1, Example 9, Example 10, and Comparative Example 2.

FIG. 5 shows X-ray diffraction results of solid electrolytes according to Example 1, Example 2, Example 5, and Comparative Example 1.

FIG. 6 shows X-ray diffraction results of solid electrolytes according to Example 1, Example 14, and Example 16.

FIG. 7 shows X-ray diffraction results of solid electrolytes according to Example 1, Example 22, and Example 29.

FIG. 8 shows X-ray diffraction results of solid electrolytes according to Example 10 and Example 32.

### DESCRIPTION OF EMBODIMENTS

Hereinafter, the present embodiment will be described in detail with reference to the drawings as appropriate. In the drawings used in the following description, characteristic portions may be shown by enlarging them for convenience to facilitate understanding characteristics of the present invention, and the dimensional ratios and the like of each of components may be different from those of actual components. Materials, dimensions, and the like provided as exemplary examples in the following description are merely examples, and the present invention is not limited thereto and can be implemented with appropriate changes without departing from the scope of the present invention.

[Solid Electrolyte Battery]

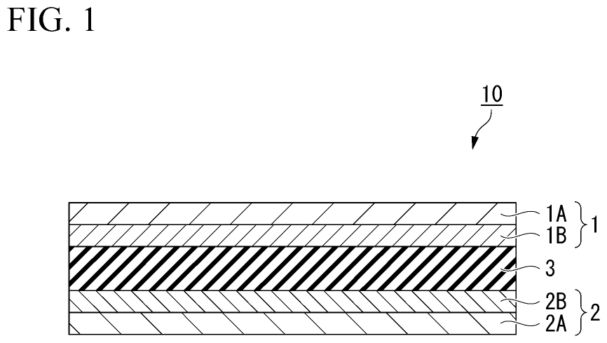

FIG. 1 is a schematic cross-sectional view of a solid electrolyte battery according to a first embodiment. As shown in FIG. 1, a solid electrolyte battery 10 includes a positive electrode 1, a negative electrode 2, and a solid electrolyte layer 3. The solid electrolyte layer 3 is sandwiched between the positive electrode 1 and the negative electrode 2. The positive electrode 1 and the negative electrode 2 are connected to external terminals to be electrically connected to the outside. An all-solid-state battery is one aspect of the solid electrolyte battery.

The solid electrolyte battery 10 is charged or discharged by the transfer of ions between the positive electrode 1 and the negative electrode 2 via the solid electrolyte layer 3. The solid electrolyte battery 10 may be a laminate in which the positive electrode 1, the negative electrode 2, and the solid electrolyte layer 3 are laminated, or may be a wound body in which the laminate is wound. The solid electrolyte battery is used for laminate batteries, square type batteries, cylindrical type batteries, coin type batteries, button type batteries, and the like, for example. Furthermore, the solid electrolyte battery may be a liquid injection type in which the solid electrolyte layer 3 is dissolved or dispersed in a solvent.

“Solid Electrolyte Layer”

The solid electrolyte layer 3 contains a solid electrolyte.

The solid electrolyte contains a compound that contains an alkali metal element, a tetravalent metal element, and a halogen element as main elements. Hereinafter, this compound is referred to as a halogenated compound.

When the solid electrolyte contains the compound having such a composition, the presence of the tetravalent metal element weakens the binding of the alkali metal by the halogen element. As a result, an ion conduction path is formed inside the solid electrolyte, which allows the alkali metal (movable ions) to move easily. Furthermore, the tetravalent metal element and the halogen element form a space in which movable ions are conducted in the crystal structure. The combination of these actions improves the ion conductivity of the solid electrolyte.

When the phrase “contains . . . as main elements” is referred to, this means that these elements are contained as basic elements constituting the compound. For example, elements forming the basic structure of the halogenated compound are an alkali metal element, a tetravalent metal element, and a halogen element. The halogenated compound may be composed of an alkali metal element, a tetravalent metal element, and a halogen element. Furthermore, the halogenated compound may be a compound in which parts of the alkali metal element, the tetravalent metal element, and the halogen element are substituted. The solid electrolyte layer mainly contains a halogenated compound, for example. The term “mainly” indicates that the halogenated compound accounts for the highest proportion in the compound contained in the solid electrolyte layer. The solid electrolyte layer may be composed of the halogenated compound.

The alkali metal element contained in the halogenated compound is any of Li, K, and Na, for example. The alkali metal element contained in the halogenated compound is preferably Li. The alkali metal element is a movable ion that moves in the solid electrolyte layer 3 in the solid electrolyte battery 10. The movable ion is an ion transferred between the positive electrode 1 and the negative electrode 2, and is a Li ion, for example.

The tetravalent metal element contained in the halogenated compound is one or more elements selected from the group consisting of Zr, Hf, Ti, Sn, and Ge, for example. The tetravalent metal element contained in the halogenated compound is preferably Zr. Zr is low cost and low weight, and enhances the stability of the battery.

The halogen element contained in the halogenated compound is one or more elements selected from the group consisting of F, Cl, Br, and I, for example. The halogen element contained in the halogenated compound is preferably Cl.

The halogenated compound may contain an element other than the alkali metal element, the tetravalent metal element, and the halogen element. For example, in addition to the alkali metal element, the tetravalent metal element, and the halogen element, monovalent to hexavalent metal elements (excluding tetravalent metal elements) may be contained. The monovalent metal element contained in the halogenated compound is Ag and Au, for example. The divalent metal element contained in the halogenated compound is Mg, Ca, Sr, Ba, Cu, Pb, and Sn, for example. The trivalent metal element contained in the halogenated compound is Y, Al, Sc, La, Ce, Pr, Nd, Pm, Sm, Eu, Gd, Tb, Dy, Ho, Er, Tm, Yb, Lu, Bi, In, Sb, and Nb, for example. The pentavalent metal element contained in the halogenated compound is Ta, for example. The hexavalent metal element contained in the halogenated compound is W, for example.

The monovalent to hexavalent metal elements (excluding tetravalent metal elements) contained in the halogenated compound are substituted with at least one of the tetravalent metal element and the alkali metal element, for example.

The halogenated compound is a compound represented by the composition formula Li₂₊ₐM_{b}Zr_{1+c}Cl_{6+d}, for example. The composition formula satisfies −1.5≤a≤1.5, 0 ≤b≤1.5, −0.7≤c≤0.2, and −0.2≤d≤0.2.

M is an element that is substituted at the Zr site or Li site. M is the above-mentioned monovalent to hexavalent metal elements (excluding tetravalent metal elements), for example. M is preferably one or more elements selected from Al, Y, Ca, Nb, and Mg. The following descriptions are definitions for each subscript in the above-mentioned composition formula. That is, a case in which the tetravalent metal element is Zr is described as an example.

When M is substituted at the Zr site as a monovalent element, the above-mentioned composition formula preferably further satisfies a=3b and 0≤b≤0.5.

When M is substituted at the Li site as a monovalent element, the above-mentioned composition formula preferably further satisfies a=−b and 0≤b≤0.5.

When M is substituted at the Zr site as a divalent element, the above-mentioned composition formula preferably further satisfies a=2b and 0≤b≤0.5. M is preferably at least one of Mg and Ca.

When M is substituted at the Li site as a divalent element, the above-mentioned composition formula preferably further satisfies a=−2b and 0≤b≤0.5. M is preferably at least one of Mg and Ca.

When M is substituted at the Zr site as a trivalent element, the above-mentioned composition formula preferably further satisfies a=b and 0≤b≤0.5. M is preferably at least one element selected from the group consisting of Al, Y, and Nb.

When M is substituted at the Li site as a trivalent element, the above-mentioned composition formula preferably further satisfies a=−3b and 0−b≤0.5. M is preferably at least one element selected from the group consisting of Al, Y, and Nb.

When M is substituted at the Zr site as a pentavalent element, the above-mentioned composition formula preferably further satisfies a=−b and 0≤b≤0.5.

When M is substituted at the Li site as a pentavalent element, the above-mentioned composition formula preferably further satisfies a=−5b and 0≤b≤0.4.

When M is substituted at the Zr site as a hexavalent element, the above-mentioned composition formula preferably further satisfies a=−2b and 0≤b≤0.5.

When M is substituted at the Li site as a hexavalent element, the above-mentioned composition formula preferably further satisfies a=−6b and 0≤b≤1/3.

When a part of the tetravalent metal element is substituted with at least one element selected from the group consisting of monovalent to trivalent elements, the number of movable ion carriers of a reduced cation content can be increased. As a result, ion conductivity of the solid electrolyte is improved.

When a part of the tetravalent metal element is substituted with at least one element selected from the group consisting of other tetravalent elements, binding of the alkali metal by the halogen element is weakened, which allows the alkali metal (movable ions) to move easily. As a result, the ion conductivity of the solid electrolyte is improved.

When a part of the tetravalent metal element is substituted with at least one element selected from the group consisting of pentavalent and hexavalent elements, the number of movable ions of an increased cation content is reduced, and the number of holes in the crystal structure is increased. As a result, ion conductivity of the solid electrolyte is improved.

The solid electrolyte is at least partially crystalline. For example, a part of the halogenated compound is crystalline. Since a part of the solid electrolyte is crystalline, a diffraction peak is confirmed when X-ray diffraction measurement is performed using CuKα rays. The solid electrolyte has diffraction peaks at positions of 2θ=32.0°±0.5° and 2θ=34.4°±0.5° for a wavelength of CuKα rays. The solid electrolyte may have diffraction peaks at positions of 2θ=32.0°±0.5° and 2θ=30.0°±0.5° for the wavelength of CuKα rays. When the diffraction peak is at a predetermined position with respect to CuKα rays, this means that diffracted light generated when light having the wavelength of CuKα rays is incident on the solid electrolyte has a diffraction peak at a predetermined position, for example.

The solid electrolyte preferably has a diffraction peak at each of positions of 2θ=16.1°±0.5°, 2θ=41.7°±0.5°, and 2θ=49.9°±0.5° with respect to CuKα rays. In addition, the solid electrolyte more preferably has a diffraction peak at each of positions of 2θ=43.7°±0.5°, 45.0°±0.5°, 2θ=54.2°±0.5°, 2θ=59.1°±0.5°, 2θ=60.5°±0.5°, and 2θ=62.2°±0.5° with respect to CuKα rays. When the solid electrolyte has the above-mentioned diffraction peaks, an ion conduction path is secured in the crystal structure, which improves ion conductivity.

In addition, the solid electrolyte further preferably has a diffraction peak at each of positions of 2θ=30.0°±0.5° and 2θ=34.4°±0.5° with respect to CuKα rays. Furthermore, these diffraction peaks are diffraction peaks associated with the halogenated compound, for example. When the above-mentioned diffraction peaks are confirmed, an ion conduction path is better secured in the crystal structure, which improves ion conductivity.

In addition, a diffraction intensity IA of the diffraction peak at 2θ=32.0°±0.5° and a diffraction intensity IB of the diffraction peak at 2θ=34.4°±0.5° preferably satisfy 0<IB/IA≤3, and more preferable satisfy 0<IB/IA≤2. By forming a crystal structure that satisfies such a specific range value, a path having a high ion conductivity is partially formed in the crystal structure, which further improves ion conductivity.

Furthermore, the diffraction intensity IA of the diffraction peak at 2θ=32.0°±0.5° and a diffraction intensity IC of the diffraction peak at 2θ=30.0°±0.5° preferably satisfy 0<IC/IA≤2, and more preferably satisfy 0<IC/IA≤1.5. By forming a crystal structure that satisfies such a specific value range, a path having a high ion conductivity is partially formed in the crystal structure, which further improves ion conductivity.

The solid electrolyte layer 3 may contain a material other than the solid electrolyte. The solid electrolyte layer 3 may contain oxides or halides of the above-mentioned alkali metal element, oxides or halides of the above-mentioned tetravalent metal element, or oxides or halides of the above-mentioned M element, for example. The solid electrolyte layer 3 preferably contains 0.1% by mass or more and 1.0% by mass or less of these materials. These materials enhance electrical insulation properties in the solid electrolyte layer 3 and improve self-discharge of the solid electrolyte battery.

The solid electrolyte layer 3 may contain a binding material. The solid electrolyte layer 3 may contain fluorine resins such as polyvinylidene fluoride (PVDF) and polytetrafluoroethylene (PTFE), cellulose, styrene-butadiene rubber, ethylene-propylene rubber, imide-based resins such as polyimide resins, and polyamide-imide resins, ion conductive polymers, and the like, for example. The ion conductive polymer is, for example, a compound in which a monomer of a polymer compound (polyether-based polymer compounds such as polyethylene oxides and polypropylene oxides, polyphosphazenes, and the like) and alkali metal salts having lithium salts such as LiClO₄, LiBF₄, LiPF₆, and LiTFSI or lithium as main components are combined. The content of the binding material is preferably 0.1% by volume or more and 30% by volume or less of the entire solid electrolyte layer 3. The binding material helps maintain favorable joining within the solid electrolyte of the solid electrolyte layer 3, prevents generation of cracks and the like within the solid electrolyte, and minimizes a decrease in ion conductivity and an increase in grain boundary resistance.

“Positive Electrode”

As shown in FIG. 1, the positive electrode 1 has a positive electrode current collector 1A and a positive electrode active material layer 1B containing a positive electrode active material, for example.

(Positive Electrode Current Collector)

The positive electrode current collector 1A preferably has high conductivity. For example, it is possible to use metals such as silver, palladium, gold, platinum, aluminum, copper, nickel, titanium, and stainless steel and alloys thereof, or conductive resins. The positive electrode current collector 1A may be in a powder, foil, punched, or expanded form.

(Positive Electrode Active Material Layer)

The positive electrode active material layer 1B is formed on one side or both sides of the positive electrode current collector 1A. The positive electrode active material layer 1B contains a positive electrode active material, and may contain a conductive auxiliary agent, a binder, and the above-mentioned solid electrolyte as necessary.

(Positive Electrode Active Material)

The positive electrode active material contained in the positive electrode active material layer 1B is, for example, a lithium-containing transition metal oxide, a transition metal fluoride, a polyanion, a transition metal sulfide, a transition metal oxyfluoride, a transition metal oxysulfide, or a transition metal oxynitride.

As long as a positive electrode active material can reversibly cause the release and occlusion of lithium ions and the desorption and insertion of lithium ions to proceed, it is not particularly limited as the positive electrode active material, and it is possible to use a positive electrode active material that has been used in known lithium ion secondary batteries. The positive electrode active material is a composite metal oxide such as a lithium cobalt oxide (LiCoO₂), a lithium nickel oxide (LiNiO₂), a spinel-type lithium manganese oxide (LiMn₂O₄), a composite metal oxide represented by the general formula: LiNiₓCo_{y}Mn_{z}MₐO₂ (where x+y+z+a=1, 0<x ≤1, 0<y ≤1, 0<z ≤1, 0≤a≤1, and M is one or more elements selected from Al, Mg, Nb, Ti, Cu, Zn, and Cr), lithium vanadium compounds (LiV₂O₅, Li₃V₂(PO₄)₃, LiVOPO₄), olivine-type LiMPO₄ (where M indicates one or more elements selected from Co, Ni, Mn, Fe, Mg, V, Nb, Ti, Al, and Zr), lithium titanate (Li₄Ti₅O₁₂), LiNiₓCo_{y}Al_{z}O₂ (0.9<x+y+z<1.1), and the like, for example.

Furthermore, when a negative electrode active material doped with metallic lithium or lithium ions is previously disposed on the negative electrode, a positive electrode active material not containing lithium can be used by starting the battery from discharging. Examples of such a positive electrode active material include lithium-free metal oxides (MnO₂, V₂O₅, and the like), lithium-free metal sulfides (MoS₂ and the like), lithium-free fluorides (FeF₃, VF₃, and the like), and the like.

“Negative Electrode”

As shown in FIG. 1, the negative electrode 2 has a negative electrode current collector 2A and a negative electrode active material layer 2B containing a negative electrode active material.

(Negative Electrode Current Collector)

The negative electrode current collector 2A preferably has high conductivity. For example, it is preferable to use metals such as silver, palladium, gold, platinum, aluminum, copper, nickel, stainless steel, and iron and alloys thereof, or conductive resins. The negative electrode current collector 2A may be in a powder, foil, punched, or expanded form.

(Negative Electrode Active Material Layer)

The negative electrode active material layer 2B is formed on one side or both sides of the negative electrode current collector 2A. The negative electrode active material layer 2B contains a negative electrode active material, and may contain a conductive auxiliary agent, a binder, and the above-mentioned solid electrolyte as necessary.

(Negative Electrode Active Material)

It is sufficient for the negative electrode active material contained in the negative electrode active material layer 2B to be any compound that can occlude and release movable ions, and it is possible to use a negative electrode active material that has been used in known lithium ion secondary batteries. Examples of the negative electrode active material include alkali metal simple substances, alkali metal alloys, carbon materials such as graphite (natural graphite, artificial graphite), carbon nanotubes, hardly graphitizable carbons, easily graphitizable carbons, and low temperature-calcined carbons, metals that can be combined with metals such as alkali metals such as aluminum, silicon, tin, germanium, and alloys thereof, oxides such as SiOₓ (0<x<2), iron oxides, titanium oxides, and tin dioxides, and lithium metal oxides such as lithium titanate (Li₄Ti₅O₁₂).

(Conductive Auxiliary Agent)

The conductive auxiliary agent is not particularly limited as long as it improves electron conductivity of the positive electrode active material layer 1B and the negative electrode active material layer 2B, and a known conductive auxiliary agent can be used. Examples of the conductive auxiliary agent include carbon-based materials such as graphite, carbon black, graphene, and carbon nanotubes, metals such as gold, platinum, silver, palladium, aluminum, copper, nickel, stainless steel, and iron, and conductive oxides such as ITO, or mixtures thereof. The above-mentioned conductive auxiliary agent may be in a powder or fiber form.

(Binding Material)

The binding material joins the positive electrode current collector lA and the positive electrode active material layer 1B; the negative electrode current collector 2A and the negative electrode active material layer 2B; the positive electrode active material layer 1B, the negative electrode active material layer 2B, and the solid electrolyte layer 3; various materials constituting the positive electrode active material layer 1B; and various materials constituting the negative electrode active material layer 2B.

The binding material is preferably used in the range in which the functions of the positive electrode active material layer 1B and the negative electrode active material layer 2B are not lost. It is sufficient for the binding material to be capable of joining as described above, and examples thereof include fluororesins such as polyvinylidene fluoride (PVDF) and polytetrafluoroethylene (PTFE). Furthermore, in addition those described above, for example, cellulose, styrene-butadiene rubber, ethylene-propylene rubber, polyimide resins, polyamide-imide resins, and the like may be used as the binding material. Furthermore, a conductive polymer having electron conductivity or an ion conductive polymer having ion conductivity may be used as the binding material. Examples of the conductive polymer having electron conductivity include polyacetylene and the like. In this case, because the binding material also exerts the function of conductive auxiliary agent particles, the conductive auxiliary agent may not be added. As the ion conductive polymer having ion conductivity, for example, one that conducts lithium ions or the like can be used, and examples thereof include one in which a monomer of a polymer compound (polyether-based polymer compounds such as polyethylene oxides and polypropylene oxides, polyphosphazenes, and the like) and alkali metal salts having lithium salts such as LiClO₄, LiBF₄, and LiPF₆ or lithium as main components are combined. Examples of polymerization initiators used for the combining include photopolymerization initiators or thermal polymerization initiators compatible with the above-mentioned monomers. Examples of characteristics required for the binding material include resistance to oxidation and reduction and good adhesiveness.

The amount of the binding material in the positive electrode active material layer 1B is not particularly limited, but is preferably 0.5% to 30% by volume of the positive electrode active material layer from the viewpoint of reducing the resistance of the positive electrode active material layer 1B.

The content of the binding material in the negative electrode active material layer 2B is not particularly limited, but is preferably 0.5% to 30% by volume of the negative electrode active material layer from the viewpoint of reducing the resistance of the negative electrode active material layer 2B.

At least one of the positive electrode active material layer 1B, the negative electrode active material layer 2B, and the solid electrolyte layer 3 may contain a non-aqueous electrolytic solution, an ionic liquid, and a gel electrolyte for the purpose of improving a rate characteristic which is one of battery characteristics.

(Method for Manufacturing Solid Electrolyte)

A method for manufacturing the solid electrolyte according to the present embodiment will be described. The solid electrolyte is obtained by mixing a raw material powder at a predetermined molar ratio to set a desired composition, and reacting. A method for the reaction is not limited, but a mechanochemical milling method, a sintering method, a melting method, a liquid phase method, a solid phase method, and the like can be used.

The solid electrolyte can be manufactured by the mechanochemical milling method, for example. First, a planetary ball mill device is prepared. The planetary ball mill device is a device in which media (hard balls for promoting pulverization or a mechanochemical reaction) and materials are put into a dedicated container, and rotation and revolution are performed to pulverize the materials or cause a mechanochemical reaction between materials.

Next, a predetermined amount of zirconia balls are prepared in a container made of zirconia in a glove box which has the dew point of −80° C. or less and the oxygen concentration of 1 ppm or less and in which argon gas is circulated. Next, a predetermined raw material is prepared in a container made of zirconia at a predetermined molar ratio to set a desired composition, and the container is sealed with a lid made of zirconia. The raw material may be a powder or a liquid. For example, titanium chloride (TiCl₄), tin chloride (SnCl₄), and the like are liquids at room temperature. Next, a mechanochemical reaction is caused by performing mechanochemical milling at predetermined rotation and revolution speeds for a predetermined time. According to this method, a powdery solid electrolyte composed of a compound having a desired composition can be obtained. The mechanochemical reaction can be controlled by heating or cooling the inside of the planetary ball mill device. Heating using a heater or the like, water cooling, air cooling using a refrigerant, and the like can be used for the treatment.

In addition, when obtaining a solid electrolyte of a sintered body, a solid electrolyte of a sintered body is obtained by mixing a raw material powder containing a predetermined elemental raw material at a predetermined molar ratio, forming the mixed raw material powder into a predetermined shape, and sintering in a vacuum or in an inert gas atmosphere.

(Method for Manufacturing Solid Electrolyte Battery)

Next, a method for manufacturing the solid electrolyte battery according to the present embodiment will be described. The solid electrolyte battery according to the present embodiment can be produced by using a powder forming method.

(Powder Forming Method)

First, a resin holder having a through hole in the center, a lower punch, and an upper punch are prepared. The diameter of the through hole of the resin holder is 10 mm, for example, and the diameter of the lower punch and the upper punch is 9.99 mm, for example. The lower punch is inserted from under the through hole of the resin holder, and the powdery solid electrolyte is put from the opening side of the resin holder. Next, the upper punch is inserted from above the powdery solid electrolyte put, and the resin holder is placed on a pressing machine to perform pressing. The press pressure is 373 MPa, for example. By pressing the powdery solid electrolyte by the upper punch and the lower punch in the resin holder, the solid electrolyte layer 3 is formed.

Next, the upper punch is temporarily removed, and a material of a positive electrode active material layer is put on the upper punch side of the solid electrolyte layer 3. Thereafter, the upper punch is inserted again to perform pressing. The press pressure is 373 MPa, for example. The material of the positive electrode active material layer becomes the positive electrode active material layer 1B by pressing.

Next, the lower punch is temporarily removed, and a material of a negative electrode active material layer is put on the lower punch side of the solid electrolyte layer 3. For example, the sample is turned upside down to put the material of the negative electrode active material layer on the solid electrolyte layer 3. Thereafter, the lower punch is inserted again to perform pressing. The press pressure is 373 MPa, for example. The material of the negative electrode active material layer becomes the negative electrode active material layer 1B by pressing. Through the above-mentioned procedure, the solid electrolyte battery 10 of the present embodiment is obtained.

Regarding the solid electrolyte battery 10, as necessary, using a disc made of stainless steel and a disc made of Teflon (registered trademark) having screw holes at four locations, loading may be performed in the order of the stainless steel disc/the Teflon (registered trademark) disc/the all-solid-state battery 10/the Teflon (registered trademark) disc/the stainless steel disc, and screws at the four locations may be tightened. Furthermore, the solid electrolyte battery 10 may have a similar mechanism having a shape-retaining function.

In addition, as necessary, the solid electrolyte battery may be inserted in an exterior body (aluminum laminated bag) to which an external drawer positive electrode terminal and an external drawer negative electrode terminal are attached, screws on the upper punch side surface and the external drawer positive electrode terminal inside the exterior body, and screws on the lower punch side surface and the external drawer negative electrode terminal inside the exterior body may be connected by a lead wire, and finally, an opening part of the exterior body may be heat-sealed. The exterior body improves weather resistance.

The method for manufacturing the solid electrolyte battery 10 described above has been described with the powder forming method as an example, but manufacturing may be performed by a method for forming a sheet containing a resin.

For example, first, a solid electrolyte paste containing the powdery solid electrolyte is produced. The produced solid electrolyte paste is applied to a PET film, a fluororesin film, or the like, and dried and peeled off to produce the solid electrolyte layer 3. Furthermore, a positive electrode active material paste containing a positive electrode active material is applied onto the positive electrode current collector 1A and dried to form the positive electrode active material layer 1B, and thereby the positive electrode 1 is produced. Furthermore, a paste containing a negative electrode active material is applied onto the negative electrode current collector 2A and dried to form the negative electrode mixture layer 2B, and thereby the negative electrode 2 is produced.

Next, the solid electrolyte layer 3 is sandwiched between the positive electrode 1 and the negative electrode 2, and the entire body is pressurized and adhered. By the above steps, the solid electrolyte battery 10 of the present embodiment is obtained.

The solid electrolyte battery of the present embodiment may be one in which holes of the positive electrode, a separator, and the negative electrode are filled with the solid electrolyte instead of an electrolytic solution of the conventional lithium ion secondary battery.

Such a solid electrolyte battery can be manufactured by a method described below, for example. First, a solid electrolyte paint containing a solid electrolyte of a powder state and a solvent is produced. In addition, an electrode element assembly composed of a positive electrode, a separator, and a negative electrode is produced. Then, after impregnating the electrode element assembly with the solid electrolyte paint, the solvent is removed. Accordingly, a solid electrolyte battery in which holes of the electrode element assembly are filled with the solid electrolyte is obtained.

The solid electrolyte according to the present embodiment has excellent ion conductivity as described in Examples to be described later. Therefore, the solid electrolyte battery of the present embodiment containing the solid electrolyte of the present embodiment has a small internal resistance and a large discharge capacity.

Furthermore, the solid electrolyte having a specific diffraction peak in X-ray diffraction has excellent ion conductivity. A diffraction peak of X-rays is generated when X-rays are incident on an arrangement surface in which atoms are regularly arranged, and the X-rays scattered by each atom interfere with each other and intensify each other. That is, when the phrase “having a specific diffraction peak” is referred to, this indicates that aligning properties of a part of crystals are enhanced and a specific arrangement surface is formed.

The solid electrolyte is responsible for conducting movable ions between the positive electrode 1 and the negative electrode 2. Movable ions conduct gaps between atoms constituting the solid electrolyte. When the specific arrangement surface is formed on the solid electrolyte, a conduction path of movable ions is formed between the specific arrangement surfaces. When the conduction path of movable ions is formed, the ion conductivity of the solid electrolyte is improved. It is thought that, in the solid electrolyte having a specific diffraction peak in X-ray diffraction, the conduction path of movable ions is secured, which improves the ion conductivity.

Furthermore, the solid electrolyte according to the present embodiment contains the tetravalent metal element as one of the constituent elements. For example, Patent Document 2 discloses Li_{6-3z}Y_{z}X₆ (where X is Cl or Br) as a halogenated compound. In Li_{6-3z}Y₇X₆, Y is present as trivalent Y³⁺. The ionic radius of hexacoordinate Y³⁺ is 0.9 Å. Meanwhile, regarding the tetravalent metal element contained in the solid electrolyte according to the present embodiment, the ionic radius of the tetravalent metal element is smaller than the ionic radius of hexacoordinate Y³⁺. For example, hexacoordinate Zr⁴⁺ is 0.72 Å, hexacoordinate Hf⁴⁺ is 0.71 Å, hexacoordinate Ti⁴⁺ is 0.605 Å, and hexacoordinate Sn⁴⁺ is 0.69 Å. Tetravalent ions have a smaller ionic radius and stronger electrostatic force than those of Y³⁺. Therefore, halogen ions (for example, Cl⁻) contained in the solid electrolyte are strongly bound by tetravalent ions. When the halogen ions are bound by the tetravalent ions, movable ions are less likely to be electrically affected by the halogen ions and easily move, which improves the movable ion conductivity of the solid electrolyte. Therefore, the movable ion conductivity of the solid electrolyte layer is also improved.

When the solid electrolyte according to the present embodiment contains monovalent to trivalent metal elements, for example, a part of the tetravalent metal element is substituted with monovalent to trivalent metal elements. As a result, the amount of cations in the solid electrolyte is reduced. The charge neutrality of the solid electrolyte after substitution is maintained by increasing the amount of movable ions. When the movable ions are increased, the conductivity of the movable ions of the solid electrolyte is further improved.

When the solid electrolyte according to the present embodiment contains pentavalent to hexavalent metal elements, for example, a part of the tetravalent metal element is substituted with pentavalent to hexavalent metal elements. As a result, halogen ions (for example, Cl⁻) contained in the solid electrolyte are further strongly bound by pentavalent or hexavalent ions. Since the movable ions are less likely to be electrically affected by the halogen ions, the movable ions easily conduct in the solid electrolyte, which further improves the movable ion conductivity of the solid electrolyte.

Although the embodiments of the present invention have been described in detail with reference to the drawings, each of the configurations, combinations thereof, and the like in each of the embodiments is an example, and additions, omissions, replacements, and other changes are possible within a range not deviating from the gist of the present invention.

### EXAMPLES

### Example 1

[Production of Solid Electrolyte]

Synthesis of a solid electrolyte and production of a solid electrolyte battery were performed in a glove box which had the dew point of −99° C. and the oxygen concentration of 1 ppm and in which argon gas was circulated.

In the glove box in the above-mentioned environment, raw material powders LiCl and ZrCl₄ were weighed, so that the molar ratio was 2:1, and put in a Zr container together with a Zr ball having the diameter of 5 mm to perform mechanochemical milling treatment using a planetary ball mill. In the treatment, under the condition of the rotation speed of 500 rpm, mixing was performed for 50 hours while cooling, and thereafter the mixture was sieved with a 100 μm mesh. Accordingly, a powder of Li₂ZrC₆ was obtained.

[Measurement of Ion Conductivity]

Next, in a glove box which had the dew point of −99° C. and the oxygen concentration of 1 ppm and in which argon gas was circulated, a die for pressure forming was filled with the obtained powder of Li₂ZrCl₆, and pressure forming was performed at the pressure of 373 MPa to produce an ion conductivity measurement cell.

The die for pressure forming is constituted of a resin holder having the diameter of 10 mm, and an upper punch and a lower punch having the diameter of 9.99 mm and made of an electron-conductive SKD material (die steel). The die for pressure forming was filled with 110 mg of the powder of Li₂ZrCl₆ to perform forming at the pressure of 373 MPa with a pressing machine. The formed product was used as a die after pressure forming.

Thereafter, a disc made of stainless steel and a disc made of Teflon (registered trademark) having the diameter of 50 mm and the thickness of 5 mm and having screw holes at four locations were prepared, and the die for pressure forming was set as follows. Loading was performed in the order of the stainless steel disc/the Teflon (trademark registered) disc/the die after pressure forming/the Teflon (trademark registered) disc/the stainless steel disc, and screws at four locations were tightened. In addition, screws were inserted into screw holes provided on the side surfaces of the upper and lower punches to serve as external connection terminals

The external connection terminals were connected to a potentiostat equipped with a frequency response analyzer to perform measurement of ion conductivity using an electrochemical impedance measurement method. The measurement was performed at the measurement frequency range of 7 MHz to 0.1 Hz, the amplitude of 10 mV, and the temperature of 25° C.

The measured ion conductivity of the solid electrolyte of Example 1 was 5.0×10⁻⁴ S/cm.

[XRD Measurement]

In a glove box which had the dew point of −99° C. and the oxygen concentration of 1 ppm and in which argon gas was circulated, a holder for XRD measurement was filled with the obtained powder of Li₂ZrCl₆. Thereafter, sealing was performed by attaching a Kapton tape (one vacuum-dried at 70° C. for 16 hours) for moisture proofing to cover the filled surface, and an XRD measurement sample was prepared. Then, the sample was taken out into the atmosphere, and XRD measurement was performed using an X-ray diffractometer (X'Pert Pro manufactured by PANalytical). As an X-ray source, Cu-Kα rays were used.

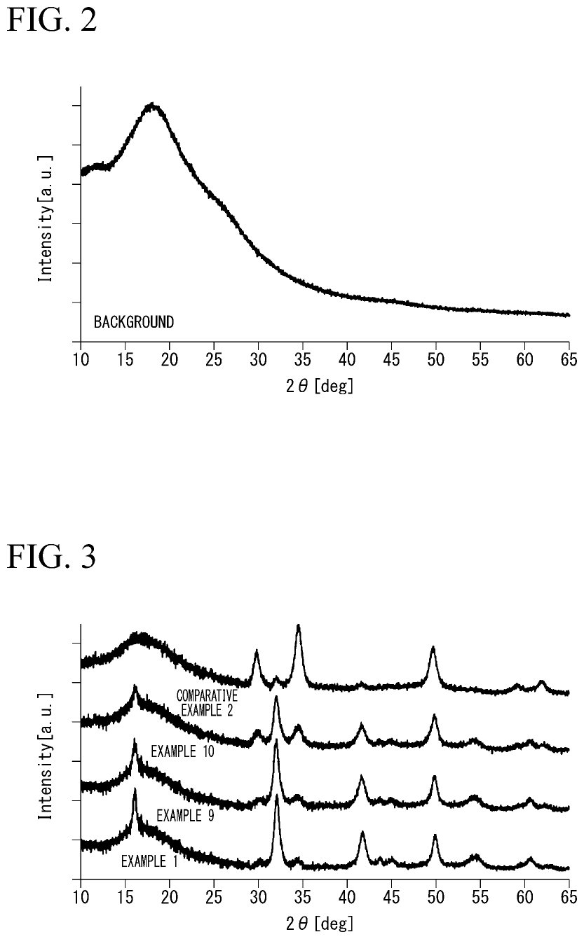

Furthermore, under the same conditions as those of the XRD measurement, only the Kapton tape used for moisture proofing was attached to the holder for XRD measurement to perform background measurement. FIG. 2 shows the measured X-ray diffraction results of the Kapton tape.

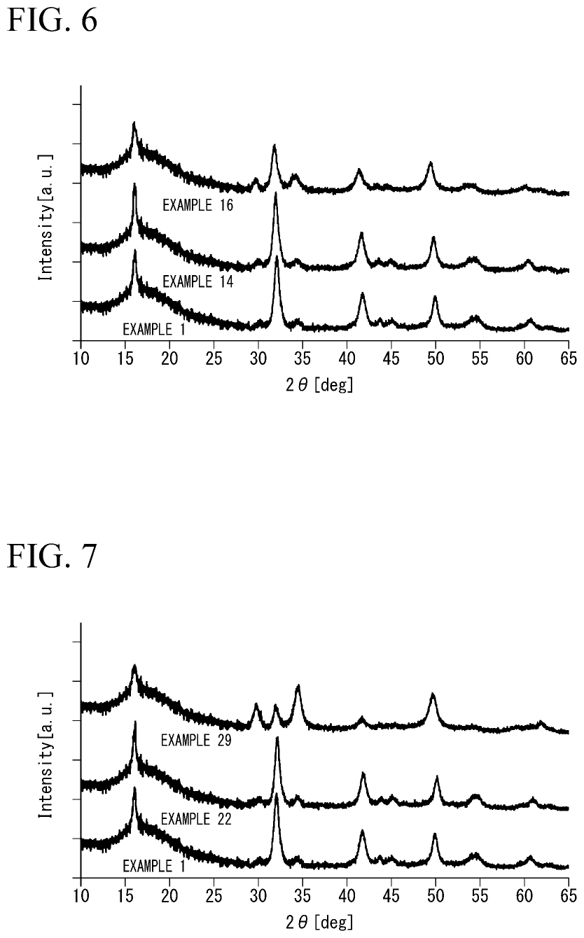

FIGS. 3 and 5 to 7 show the X-ray diffraction results of the solid electrolyte according to Example 1. FIG. 3 collectively shows the results of Example 9, Example 10, and Comparative Example 2 which will be described later. FIG. 5 collectively shows the results of Example 2, Example 5, and Comparative Example 1 which will be described later. FIG. 6 collectively shows the results of Example 14 and Example 16 which will be described later. FIG. 7 collectively shows the results of Example 22 and Example 29 which will be described later. For the convenience of displaying several types of examples, they are displayed in arbitrary units. A diffraction peak in each of the examples was obtained by subtracting the background from the X-ray diffraction results measured in each of the examples.

For the solid electrolyte according to Example 1, a diffraction peak was observed at each of the positions of 2θ=16.1°, 30.1°, 32.0°, 34.4°, 41.7°, 43.7°, 45.1°, 49.9°, 53.9°, 54.8°, 59.4°, 60.7°, and 62.3°.

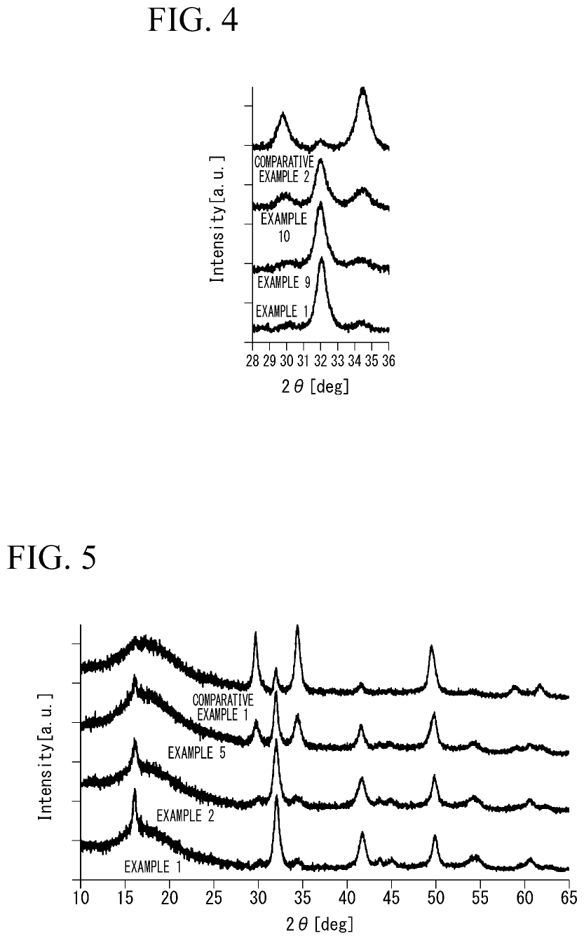

FIG. 4 shows a graph showing the relationship between IB/IA and IC/IA. FIG. 4 is a graph in which vicinities of the diffraction angle of 30° in FIG. 2 are enlarged. The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 1 was 0.195.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 1 was 0.151.

### Example 2

Example 2 was different from Example 1 in that aluminum chloride was added to the raw material powder. The molar ratio of LiCl, AlCl₃, and ZrCl₄ was 2.1:0.1:0.9. A powder of Li_{2.1}Al_{0.1}Zr_{0.9}Cl₆ was obtained by a mixing reaction of the raw material powder. Other conditions were the same as those of Example 1, and ion conductivity and X-ray diffraction were performed.

The ion conductivity of the solid electrolyte according to Example 2 was 8.5×10⁻⁴ S/cm.

The solid electrolyte according to Example 2 had a diffraction peak at each of the positions of 2θ=16.1°, 30.0°, 32.0°, 34.4°, 41.7°, 43.6°, 44.9°, 49.8°, 54.2°, 54.6°, 59.4, 60.5°, and 62.4°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 2 was 0.187.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 2 was 0.145.

### Example 3

Example 3 was different from Example 1 in that aluminum chloride was added to the raw material powder, and was different from Example 2 in that the mixing ratio is different. The molar ratio of LiCl, AlCl₃, and ZrCl₄ was 2.2:0.2:0.8. A powder of Li_{2.2}Al_{0.2}Zr_{0.8}Cl₆ was obtained by a mixing reaction of the raw material powder. Other conditions were the same as those of Example 1, and ion conductivity and X-ray diffraction were performed.

The ion conductivity of the solid electrolyte according to Example 3 was 7.0×10⁻⁴ S/cm.

The solid electrolyte according to Example 3 had a diffraction peak at each of the positions of 2θ=16.1°, 30.0°, 32.0°, 34.4°, 41.7°, 43.6°, 44.9°, 49.8°, 54.2°, 54.6°, 59.4°, 60.5°, and 61.9°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 3 was 0.347.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 3 was 0.285.

### Example 4

Example 4 was different from Example 1 in that aluminum chloride was added to the raw material powder, and was different from Example 2 in that the mixing ratio is different. The molar ratio of LiCl, AlCl₃, and ZrCl₄ was 2.25:0.25:0.75. A powder of Li_{2.25}Al_{0.25}Zr_{0.75}Cl₆ was obtained by a mixing reaction of the raw material powder. Other conditions were the same as those of Example 1, and ion conductivity and X-ray diffraction were performed.

The ion conductivity of the solid electrolyte according to Example 4 was 5.8×10⁻⁴ S/cm.

The solid electrolyte according to Example 4 had a diffraction peak at each of the positions of 2θ=16.1°, 30.0°, 32.0°, 34.4°, 41.7°, 43.6°, 45.0°, 49.9°, 54.2°, 54.6°, 59.0°, 60.5°, and 61.9°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Example 4 was 0.452.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 4 was 0.372.

### Example 5

Example 5 was different from Example 1 in that aluminum chloride was added to the raw material powder, and was different from Example 2 in that the mixing ratio is different. The molar ratio of LiCl, AlCl₃, and ZrCl₄ was 2.3:0.3:0.7. A powder of Li_{2.3}Al_{0.3}Zr_{0.7}Cl₆ was obtained by a mixing reaction of the raw material powder. Other conditions were the same as those of Example 1, and ion conductivity and X-ray diffraction were performed.

The ion conductivity of the solid electrolyte according to Example 5 was 5.1×10⁻⁴ S/cm.

The solid electrolyte according to Example 5 had a diffraction peak at each of the positions of 2θ=16.1°, 29.8°, 32.0°, 34.4°, 41.7°, 43.6°, 45.0°, 49.9°, 54.2°, 54.6°, 59.0°, 60.5°, and 61.9°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 5 was 0.549.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 5 was 0.460.

### Example 6

Example 6 was different from Example 1 in that aluminum chloride was added to the raw material powder, and was different from Example 2 in that the mixing ratio is different. The molar ratio of LiCl, AlCl₃, and ZrCl₄ was 2.35:0.35:0.65. A powder of Li_{2.35}Al_{0.35}Zr_{0.65}Cl₆ was obtained by a mixing reaction of the raw material powder. Other conditions were the same as those of Example 1, and ion conductivity and X-ray diffraction were performed.

The ion conductivity of the solid electrolyte according to Example 6 was 4.5×10⁻⁴ S/cm.

The solid electrolyte according to Example 6 had a diffraction peak at each of the positions of 2θ=16.1°, 29.8°, 32.0°, 34.4°, 41.7°, 43.6°, 45.0°, 49.9°, 54.2°, 54.6°, 59.0°, 60.5°, and 61.8°.

The ratio IB/IA of the diffraction intensity IA of the diffraction peak at 2θ=32.0°±0.5° and the diffraction intensity TB of the diffraction peak at 2θ=34.4°±0.5° of the solid electrolyte according to Example 6 was 0.789.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 6 was 0.647.

### Example 7

Example 7 was different from Example 1 in that aluminum chloride was added to the raw material powder, and was different from Example 2 in that the mixing ratio is different. The molar ratio of LiCl, AlCl₃, and ZrCl₄ was 2.4:0.4:0.6. A powder of Li_{2.4}Al_{0.4}Zr_{0.6}Cl₆ was obtained by a mixing reaction of the raw material powder. Other conditions were the same as those of Example 1, and ion conductivity and X-ray diffraction were performed.

The ion conductivity of the solid electrolyte according to Example 7 was 4.1×10⁻⁴ S/cm.

The solid electrolyte according to Example 7 had a diffraction peak at each of the positions of 2θ=16.1°, 29.8°, 32.0°, 34.4°, 41.6°, 43.6°, 45.0°, 49.9°, 54.3°, 54.6°, 59.0°, 60.5°, and 61.8°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Example 7 was 1.290.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 7 was 1.044.

### Example 8

Example 8 was different from Example 1 in that aluminum chloride was added to the raw material powder, and was different from Example 2 in that the mixing ratio is different. The molar ratio of LiCl, AlCl₃, and ZrCl₄ was 2.45:0.45:0.55. A powder of Li2.45Al_{0.45}Zr_{0.55}Cl₆ was obtained by a mixing reaction of the raw material powder. Other conditions were the same as those of Example 1, and ion conductivity and X-ray diffraction were performed.

The ion conductivity of the solid electrolyte according to Example 8 was 3.9×10⁻⁴ S/cm.

The solid electrolyte according to Example 8 had a diffraction peak at each of the positions of 2θ=16.1°, 29.7°, 32.0°, 34.4°, 41.6°, 43.6°, 44.9°, 49.4°, 54.3°, 54.6°, 59.0°, 60.5°, and 61.7°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 8 was 2.018.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 8 was 1.578.

### Comparative Example 1

Comparative Example 1 was different from Example 1 in that aluminum chloride was added to the raw material powder, and was different from Example 2 in that the mixing ratio is different. The molar ratio of LiCl, AlCl₃, and ZrCl₄ was 2.5:0.5:0.5. A powder of Li_{2.5}Al_{0.5}Zr_{0.5}Cl₆ was obtained by a mixing reaction of the raw material powder. Other conditions were the same as those of Example 1, and ion conductivity and X-ray diffraction were performed.

The ion conductivity of the solid electrolyte according to Comparative Example 1 was 3.4×10⁻⁴ S/cm.

The solid electrolyte according to Comparative Example 1 had a diffraction peak at each of the positions of 2θ=16.1°, 29.7°, 32.0°, 34.4°, 41.6°, 43.6°, 44.9°, 49.4°, 54.3°, 54.6°, 58.8, 60.5°, and 61.7°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Comparative Example 1 was 3.026.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Comparative Example 1 was 2.409.

### Example 9

Example 9 was different from Example 1 in that the proportions of the raw material powder was changed. The molar ratio of LiCl and ZrCl₄ was 2.2:0.95. A powder of Li_{2.2}Zr_{0.95}Cl₆ was obtained by a mixing reaction of the raw material powder. Other conditions were the same as those of Example 1, and ion conductivity and X-ray diffraction were performed.

The ion conductivity of the solid electrolyte according to Example 9 was 4.5×10⁻⁴ S/cm.

The solid electrolyte according to Example 9 had a diffraction peak at each of the positions of 2θ=16.0°, 30.0°, 32.0°, 34.4°, 41.6°, 43.6°, 44.9°, 49.7°, 54.2°, 54.7°, 59.4°, 60.5°, and 62.1°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 9 was 0.239.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 9 was 0.137.

### Example 10

Example 10 was different from Example 1 in that the proportions of the raw material powder was changed. The molar ratio of LiCI and ZrCl₄ was 2.4:0.9. A powder of Li_{2.4}Zr_{0.9}Cl₆ was obtained by a mixing reaction of the raw material powder. Other conditions were the same as those of Example 1, and ion conductivity and X-ray diffraction were performed.

The ion conductivity of the solid electrolyte according to Example 10 was 6.7×10⁻⁴ S/cm.

The solid electrolyte according to Example 10 had a diffraction peak at each of the positions of 2θ=16.1°, 29.9°, 31.9°, 34.5°, 41.6°, 43.6°, 44.8°, 49.8°, 54.2°, 54.7°, 59.4°, 60.5°, and 62.2°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 10 was 0.520.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 10 was 0.342.

### Example 11

Example 11 was different from Example 1 in that the proportions of the raw material powder was changed. The molar ratio of LiCl and ZrCl₄ was 2.5:0.875. A powder of Li_{2.5}Zr_{0.875}Cl₆ was obtained by a mixing reaction of the raw material powder. Other conditions were the same as those of Example 1, and ion conductivity and X-ray diffraction were performed.

The ion conductivity of the solid electrolyte according to Example 11 was 7.1×10⁻⁴ S/cm.

The solid electrolyte according to Example 11 had a diffraction peak at each of the positions of 2θ=16.1°, 29.9°, 31.9°, 34.5°, 41.6°, 43.7°, 44.8°, 49.8°, 54.2°, 54.7°, 59.4°, 60.5°, and 62.2°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 11 was 0.873.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 11 was 0.524.

### Example 12

Example 12 was different from Example 1 in that the proportions of the raw material powder was changed. The molar ratio of LiCl and ZrCl₄ was 2.6:0.85. A powder of Li_{2.5}Zr_{0.875}Cl₆ was obtained by a mixing reaction of the raw material powder. Other conditions were the same as those of Example 1, and ion conductivity and X-ray diffraction were performed.

The ion conductivity of the solid electrolyte according to Example 12 was 5.5×10⁻⁴ S/cm.

The solid electrolyte according to Example 12 had a diffraction peak at each of the positions of 2θ=16.1°, 29.9°, 31.9°, 34.5°, 41.6°, 43.7°, 44.7°, 49.8°, 54.2°, 54.7°, 59.4°, 60.5°, and 62.3°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 12 was 1.709.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 12 was 0.962.

### Example 13

Example 13 was different from Example 1 in that the proportions of the raw material powder was changed. The molar ratio of LiCl and ZrCl₄ was 2.7:0.825. A powder of Li_{2.7}Zr_{0.825}Cl₆ was obtained by a mixing reaction of the raw material powder. Other conditions were the same as those of Example 1, and ion conductivity and X-ray diffraction were performed.

The ion conductivity of the solid electrolyte according to Example 13 was 4.4×10⁻⁴ S/cm.

The solid electrolyte according to Example 13 had a diffraction peak at each of the positions of 2θ=16.1°, 29.8°, 31.9°, 34.4°, 41.6°, 43.7°, 44.7°, 49.7°, 54.2°, 54.7°, 59.4°, 60.2°, and 62.0°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Example 13 was 2.831.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 13 was 1.540.

### Comparative Example 2

Comparative Example 2 was different from Example 1 in that the proportions of the raw material powder was changed. The molar ratio of LiCl and ZrCl₄ was 2.8:0.8. A powder of Li_{2.8}Zr_{0.5}Cl₆ was obtained by a mixing reaction of the raw material powder. Other conditions were the same as those of Example 1, and ion conductivity and X-ray diffraction were performed.

The ion conductivity of the solid electrolyte according to Comparative Example 2 was 3.6×10⁻⁴ S/cm.

The solid electrolyte according to Comparative Example 2 had a diffraction peak at each of the positions of 2θ=16.1°, 29.7°, 31.9°, 34.3°, 41.6°, 43.7°, 44.7°, 49.7°, 54.1°, 54.7°, 59.4°, 60.1°, and 61.7°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Comparative Example 2 was 4.522.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Comparative Example 2 was 2.355.

### Example 14

Example 14 was different from Example 1 in that yttrium chloride was added to the raw material powder. The molar ratio of LiCl, YCl₃, and ZrCl₄ was 2.1:0.1:0.9. A powder of Li_{2.1}Y_{0.1}Zr_{0.9}Cl₆ was obtained by a mixing reaction of the raw material powder. Other conditions were the same as those of Example 1, and ion conductivity and X-ray diffraction were performed.

The ion conductivity of the solid electrolyte according to Example 14 was 5.8×10⁻⁴ S/cm.

The solid electrolyte according to Example 14 had a diffraction peak at each of the positions of 2θ=16.0°, 30.0°, 32.0°, 34.2°, 41.7°, 43.5°, 44.8°, 49.8°, 53.8°, 54.5°, 59.6°, 60.5°, and 62.5°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Example 14 was 0.213.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 14 was 0.184.

### Example 15

Example 15 was different from Example 1 in that yttrium chloride was added to the raw material powder, and is different from Example 14 in that the mixing ratio is different. The molar ratio of LiCl, YCl₃, and ZrCl₄ was 2.2:0.2:0.8. A powder of Li_{2.2}Y_{0.2}Zr_{0.8}Cl₆ was obtained by a mixing reaction of the raw material powder. Other conditions were the same as those of Example 1, and ion conductivity and X-ray diffraction were performed.

The ion conductivity of the solid electrolyte according to Example 15 was 6.6×10⁻⁴ S/cm.

The solid electrolyte according to Example 15 had a diffraction peak at each of the positions of 2θ=16.0°, 30.0°, 32.0°, 34.2°, 41.7°, 43.5°, 44.8°, 49.8°, 53.8°, 54.5°, 59.6°, 60.5°, and 62.5°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 15 was 0.318.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 15 was 0.245.

### Example 16

Example 16 was different from Example 1 in that yttrium chloride was added to the raw material powder, and was different from Example 14 in that the mixing ratio is different. The molar ratio of LiCl, YCl₃, and ZrCl₄ was 2.3:0.3:0.7. A powder of Li_{2.3}Y_{0.3}Zr_{0.7}Cl₆ was obtained by a mixing reaction of the raw material powder. Other conditions were the same as those of Example 1, and ion conductivity and X-ray diffraction were performed.

The ion conductivity of the solid electrolyte according to Example 16 was 6.3×10⁻⁴ S/cm.

The solid electrolyte according to Example 16 had a diffraction peak at each of the positions of 2θ=16.0°, 29.8°, 31.8°, 34.1°, 41.7°, 43.5°, 44.8°, 49.7°, 53.8°, 54.5°, 59.6°, 60.4°, and 62.3°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 16 was 0.492.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 16 was 0.348.

### Example 17

Example 17 was different from Example 1 in that yttrium chloride was added to the raw material powder, and was different from Example 14 in that the mixing ratio is different. The molar ratio of LiCl, YCl₃, and ZrCl₄ was 2.4:0.4:0.6. A powder of Li_{2.4}Y_{0.4}Zr_{0.6}Cl₆ was obtained by a mixing reaction of the raw material powder. Other conditions were the same as those of Example 1, and ion conductivity and X-ray diffraction were performed.

The ion conductivity of the solid electrolyte according to Example 17 was 5.5×10⁻⁴ S/cm.

The solid electrolyte according to Example 17 had a diffraction peak at each of the positions of 2θ=16.0°, 29.8°, 31.7°, 34.1°, 41.5°, 43.4°, 44.7°, 49.6°, 53.8°, 54.4°, 59.4°, 60.3°, and 62.1°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 17 was 0.841.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 17 was 0.557.

### Example 18

Example 18 was different from Example 1 in that yttrium chloride was added to the raw material powder, and was different from Example 14 in that the mixing ratio is different. The molar ratio of LiCl, YCl₃, and ZrCl₄ was 2.5:0.5:0.5. A powder of Li_{2.5}Y_{0.5}Zr_{0.5}Cl₆ was obtained by a mixing reaction of the raw material powder. Other conditions were the same as those of Example 1, and ion conductivity and X-ray diffraction were performed.

The ion conductivity of the solid electrolyte according to Example 18 was 4.4×10⁻⁴ S/cm.

The solid electrolyte according to Example 18 had a diffraction peak at each of the positions of 2θ=15.9°, 29.7°, 31.6°, 34.1°, 41.4°, 43.4°, 44.7°, 49.6°, 53.8°, 54.4°, 59.2°, 60.2°, and 62.0°.

The ratio IB/IA of the diffraction intensity IA of the diffraction peak at 2θ=32.0°±0.5° and the diffraction intensity 1B of the diffraction peak at 2θ=34.4°±0.5° of the solid electrolyte according to Example 18 was 1.188.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 18 was 0.748.

### Example 19

Example 19 was different from Example 1 in that yttrium chloride was added to the raw material powder, and was different from Example 14 in that the mixing ratio is different. The molar ratio of LiCl, YCl₃, and ZrCl₄ was 2.6:0.6:0.4. A powder of Li_{2.6}Y_{0.6}Zr_{0.4}Cl₆ was obtained by a mixing reaction of the raw material powder. Other conditions were the same as those of Example 1, and ion conductivity and X-ray diffraction were performed.

The ion conductivity of the solid electrolyte according to Example 19 was 3.8×10⁻⁴ S/cm.

The solid electrolyte according to Example 19 had a diffraction peak at each of the positions of 2θ=15.9°, 29.7°, 31.6°, 34.0°, 41.3°, 43.3°, 44.6°, 49.4°, 53.7°, 54.4°, 59.0°, 60.2°, and 61.9°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 19 was 2.218.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 19 was 1.344.

### Comparative Example 3

Comparative Example 3 was different from Example 1 in that yttrium chloride was added to the raw material powder, and was different from Example 14 in that the mixing ratio is different. The molar ratio of LiCl, YCl₃, and ZrCl₄ was 2.7:0.7:0.3. A powder of Li_{2.7}Y_{0.7}Zr_{0.3}Cl₆ was obtained by a mixing reaction of the raw material powder. Other conditions were the same as those of Example 1, and ion conductivity and X-ray diffraction were performed.

The ion conductivity of the solid electrolyte according to Comparative Example 3 was 3.4×10⁻⁴ S/cm.

The solid electrolyte according to Comparative Example 3 had a diffraction peak at each of the positions of 2θ=15.9°, 29.6°, 31.5°, 34.0°, 41.2°, 43.2°, 44.5°, 49.4°, 53.7°, 54.4°, 58.9°, 60.1°, and 61.7°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Comparative Example 3 was 3.533.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Comparative Example 3 was 2.071.

### Example 20

Example 20 was different from Example 1 in that niobium chloride was added to the raw material powder. The molar ratio of LiCl, NbCl₅, and ZrCl₄ was 1.9:0.1:0.9. A powder of Li_{1.9}Nb_{0.1}Zr_{0.9}Cl₆ was obtained by a mixing reaction of the raw material powder. Other conditions were the same as those of Example 1, and ion conductivity and X-ray diffraction were performed.

The ion conductivity of the solid electrolyte according to Example 20 was 4.4×10⁻⁴ S/cm.

The solid electrolyte according to Example 20 had a diffraction peak at each of the positions of 2θ=16.1°, 30.0°, 32.0°, 34.4°, 41.7°, 43.6°, 44.9°, 49.8°, 54.1°, 54.6°, 59.4°, 60.5°, and 62.4°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 20 was 0.177.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 20 was 0.104.

### Example 21

Example 21 was different from Example 1 in that niobium chloride was added to the raw material powder, and was different from Example 20 in that the mixing ratio is different. The molar ratio of LiCl, NbCl₅ and ZrCl₄ was 1.8:0.2:0.8. A powder of Li_{1.8}Nb_{0.2}Zr_{0.8}Cl₆ was obtained by a mixing reaction of the raw material powder. Other conditions were the same as those of Example 1, and ion conductivity and X-ray diffraction were performed.

The ion conductivity of the solid electrolyte according to Example 21 was 5.0×10⁻⁴ S/cm.

The solid electrolyte according to Example 21 had a diffraction peak at each of the positions of 2θ=16.1°, 30.0°, 32.0°, 34.4°, 41.8°, 43.7°, 45.0°, 49.9°, 54.2°, 54.6°, 59.4°, 60.5°, and 62.4°.

The ratio IB/IA of the diffraction intensity IA of the diffraction peak at 2θ=32.0°±0.5° and the diffraction intensity 1B of the diffraction peak at 2θ=34.4°±0.5° of the solid electrolyte according to Example 21 was 0.169.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 21 was 0.135.

### Example 22

Example 22 was different from Example 1 in that niobium chloride was added to the raw material powder, and was different from Example 20 in that the mixing ratio is different. The molar ratio of LiCl, NbCl₅, and ZrCl₄ was 1.7:0.3:0.7. A powder of Li_{1.7}Nb_{0.3}Zr_{0.7}Cl₆ was obtained by a mixing reaction of the raw material powder. Other conditions were the same as those of Example 1, and ion conductivity and X-ray diffraction were performed.

The ion conductivity of the solid electrolyte according to Example 22 was 5.4×10⁻⁴ S/cm.

The solid electrolyte according to Example 22 had a diffraction peak at each of the positions of 2θ=16.2°, 30.1°, 32.1°, 34.3°, 41.9°, 43.9°, 45.1°, 49.9°, 54.2°, 54.7°, 59.5°, 60.9°, and 62.5°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Example 22 was 0.229.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 22 was 0.180.

### Example 23

Example 23 was different from Example 1 in that niobium chloride was added to the raw material powder, and was different from Example 20 in that the mixing ratio is different. The molar ratio of LiCl, NbCl₅, and ZrCl₄ was 1.6:0.4:0.6. A powder of Li_{1.6}Nb_{0.4}Zr_{0.6}Cl₆ was obtained by a mixing reaction of the raw material powder. Other conditions were the same as those of Example 1, and ion conductivity and X-ray diffraction were performed.

The ion conductivity of the solid electrolyte according to Example 23 was 5.9×10⁻⁴ S/cm.

The solid electrolyte according to Example 23 had a diffraction peak at each of the positions of 2θ=16.2°, 30.1°, 32.1°, 34.3°, 41.9°, 43.9°, 45.1°, 50.0°, 54.2°, 54.7°, 59.5°, 60.9°, and 62.5°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 23 was 0.362.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 23 was 0.257.

### Example 24

Example 24 was different from Example 1 in that niobium chloride was added to the raw material powder, and was different from Example 20 in that the mixing ratio is different. The molar ratio of LiCl, NbCl₅, and ZrCl₄ was 1.5:0.5:0.5. A powder of Li_{1.5}Nb_{0.5}Zr_{0.5}Cl₆ was obtained by a mixing reaction of the raw material powder. Other conditions were the same as those of Example 1, and ion conductivity and X-ray diffraction were performed.

The ion conductivity of the solid electrolyte according to Example 24 was 5.4×10⁻⁴ S/cm.

The solid electrolyte according to Example 24 had a diffraction peak at each of the positions of 2θ=16.2°, 30.1°, 32.1°, 34.3°, 41.9°, 43.9°, 45.1°, 50.0°, 54.2°, 54.7°, 59.5°, 61.0°, and 62.6°.

The ratio IB/IA of the diffraction intensity IA of the diffraction peak at 2θ=32.0°±0.5° and the diffraction intensity TB of the diffraction peak at 2θ=34.4°±0.5° of the solid electrolyte according to Example 24 was 0.654.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 24 was 0.429.

### Example 25

Example 25 was different from Example 1 in that niobium chloride was added to the raw material powder, and was different from Example 20 in that the mixing ratio is different. The molar ratio of LiCl, NbCl₅, and ZrCl₄ was 1.4:0.6:0.4. A powder of Li_{1.4}Nb_{0.6}Zr_{0.4}Cl₆ was obtained by a mixing reaction of the raw material powder. Other conditions were the same as those of Example 1, and ion conductivity and X-ray diffraction were performed.

The ion conductivity of the solid electrolyte according to Example 25 was 4.4×10⁻⁴ S/cm.

The solid electrolyte according to Example 25 had a diffraction peak at each of the positions of 2θ=16.2°, 30.2°, 32.2°, 34.2°, 42.0°, 43.9°, 45.1°, 50.0°, 54.3°, 54.7°, 59.5°, 61.0°, and 62.6°.

The ratio TB/IA of the diffraction intensity IA of the diffraction peak at 2θ=32.0°±0.5° and the diffraction intensity IB of the diffraction peak at 2θ=34.4°±0.5° of the solid electrolyte according to Example 25 was 1.602.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 25 was 1.007.

### Example 26

Example 26 was different from Example 1 in that niobium chloride was added to the raw material powder, and was different from Example 20 in that the mixing ratio is different. The molar ratio of LiCl, NbCl₅, and ZrCl₄ was 1.3:0.7:0.3. A powder of Li_{1.3}Nb_{0.7}Zr_{0.3}Cl₆ was obtained by a mixing reaction of the raw material powder. Other conditions were the same as those of Example 1, and ion conductivity and X-ray diffraction were performed.

The ion conductivity of the solid electrolyte according to Example 26 was 3.8×10⁻⁴ S/cm.

The solid electrolyte according to Example 26 had a diffraction peak at each of the positions of 2θ=16.3°, 30.2°, 32.2°, 34.2°, 42.0°, 44.0°, 45.2°, 50.1°, 54.4°, 54.7°, 59.6°, 61.0°, and 62.7°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 26 was 2.895.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 26 was 1.763.

### Example 27

Example 27 was different from Example 1 in that magnesium chloride was added to the raw material powder. The molar ratio of LiCl, MgCl₂, and ZrCl₄ was 2.1:0.05:0.95. A powder of Li_{2.1}Mg_{0.05}Zr_{0.95}Cl₆ was obtained by a mixing reaction of the raw material powder. Other conditions were the same as those of Example 1, and ion conductivity and X-ray diffraction were performed.

The ion conductivity of the solid electrolyte according to Example 27 was 5.5×10⁻⁴ S/cm.

The solid electrolyte according to Example 27 had a diffraction peak at each of the positions of 2θ=16.1°, 30.1°, 32.1°, 34.4°, 41.8°, 43.7°, 45.1°, 49.9°, 53.9°, 54.6°, 59.4°, 60.7°, and 62.3°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 27 was 1.191.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 27 was 0.655.

### Example 28

Example 28 was different from Example 1 in that magnesium chloride was added to the raw material powder, and was different from Example 27 in that the mixing ratio is different. The molar ratio of LiCl, MgCl₂, and ZrCl₄ was 2.2:0.1:0.9. A powder of Li_{2.2}Mg_{0.1}Zr_{0.9}Cl₆ was obtained by a mixing reaction of the raw material powder. Other conditions were the same as those of Example 1, and ion conductivity and X-ray diffraction were performed.

The ion conductivity of the solid electrolyte according to Example 28 was 6.0×10⁻⁴ S/cm.

The solid electrolyte according to Example 28 had a diffraction peak at each of the positions of 2θ=16.1°, 30.2°, 32.1°, 34.4°, 41.8°, 43.7°, 45.1°, 49.8°, 54.0°, 54.6°, 59.4°, 60.7°, and 62.2°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 28 was 1.495.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 28 was 0.838.

### Example 29

Example 29 was different from Example 1 in that magnesium chloride was added to the raw material powder, and was different from Example 27 in that the mixing ratio is different. The molar ratio of LiCl, MgCl₂, and ZrCl₄ was 2.3:0.15:0.85. A powder of Li_{2.3}Mg_{0.15}Zr_{0.85}Cl₆ was obtained by a mixing reaction of the raw material powder. Other conditions were the same as those of Example 1, and ion conductivity and X-ray diffraction were performed. FIG. 7 shows the X-ray diffraction results. For the convenience of displaying several types of examples, they are displayed in arbitrary units.

The ion conductivity of the solid electrolyte according to Example 29 was 4.5×10⁻⁴ S/cm.

The solid electrolyte according to Example 29 had a diffraction peak at each of the positions of 2θ=16.1°, 30.3°, 31.9°, 34.4°, 41.8°, 43.7°, 45.1°, 49.8°, 54.1°, 54.6°, 59.3°, 60.6°, and 61.8°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 29 was 1.757.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 29 was 1.008.

### Example 30

Example 30 was different from Example 1 in that magnesium chloride was added to the raw material powder, and was different from Example 27 in that the mixing ratio is different. The molar ratio of LiCl, MgCl₂, and ZrCl₄ was 2.4:0.2:0.8. A powder of Li_{2.4}Mg_{0.2}Zr_{0.8}Cl₆ was obtained by a mixing reaction of the raw material powder. Other conditions were the same as those of Example 1, and ion conductivity and X-ray diffraction were performed.

The ion conductivity of the solid electrolyte according to Example 30 was 4.3×10⁻⁴ S/cm.

The solid electrolyte according to Example 30 had a diffraction peak at each of the positions of 2θ=16.1°, 30.3°, 31.9°, 34.4°, 41.8°, 43.6°, 45.0°, 49.7°, 54.1°, 54.7°, 59.3°, 60.6°, and 61.8°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 30 was 2.177.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 30 was 1.233.

### Example 31

Example 31 was different from Example 1 in that magnesium chloride was added to the raw material powder, and was different from Example 27 in that the mixing ratio is different. The molar ratio of LiCl, MgCl₂, and ZrCl₄ was 2.6:0.3:0.7. A powder of Li_{2.6}Mg_{0.3}Zr_{0.7}Cl₆ was obtained by a mixing reaction of the raw material powder. Other conditions were the same as those of Example 1, and ion conductivity and X-ray diffraction were performed.

The ion conductivity of the solid electrolyte according to Example 31 was 3.9×10⁻⁴ S/cm.

The solid electrolyte according to Example 31 had a diffraction peak at each of the positions of 2θ=16.1°, 30.3°, 31.9°, 34.4°, 41.7°, 43.6°, 45.0°, 49.7°, 54.2°, 54.7°, 59.2°, 60.5°, and 61.7°.

The ratio IB/IA of the diffraction intensity IA of the diffraction peak at 2θ=32.0°±0.5° and the diffraction intensity 1B of the diffraction peak at 2θ=34.4°±0.5° of the solid electrolyte according to Example 31 was 2.786.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 31 was 1.552.

### Comparative Example 4

Comparative Example 4 was different from Example 1 in that magnesium chloride was added to the raw material powder, and was different from Example 27 in that the mixing ratio is different. The molar ratio of LiCl, MgCl₂, and ZrCl₄ was 2.8:0.4:0.6. A powder of Li_{2.8}Mg_{0.4}Zr_{0.6}Cl₆ was obtained by a mixing reaction of the raw material powder. Other conditions were the same as those of Example 1, and ion conductivity and X-ray diffraction were performed.

The ion conductivity of the solid electrolyte according to Comparative Example 4 was 3.5×10⁻⁴ S/cm.

The solid electrolyte according to Comparative Example 4 had a diffraction peak at each of the positions of 2θ=16.0°, 30.2°, 31.8°, 34.5°, 41.7°, 43.5°, 45.0°, 49.7°, 54.2°, 54.7°, 59.2°, 60.5°, and 61.7°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Comparative Example 4 was 3.725.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Comparative Example 4 was 2.053.

### Comparative Example 5

Comparative Example 5 was different from Example 1 in that magnesium chloride was added to the raw material powder, and was different from Example 27 in that the mixing ratio is different. The molar ratio of LiCl, MgCl₂, and ZrCl₄ was 3.0:0.5:0.5. A powder of Li_{3.0}Mg_{0.5}Zr_{0.5}Cl₆ was obtained by a mixing reaction of the raw material powder. Other conditions were the same as those of Example 1, and ion conductivity and X-ray diffraction were performed.

The ion conductivity of the solid electrolyte according to Comparative Example 5 was 3.0×10⁻⁴ S/cm.

The solid electrolyte according to Comparative Example 5 had a diffraction peak at each of the positions of 2θ=16.0°, 30.2°, 31.8°, 34.5°, 41.6°, 43.4°, 44.9°, 49.6°, 54.3°, 54.7°, 59.1°, 60.5°, and 61.7°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Comparative Example 5 was 5.320.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Comparative Example 5 was 2.919.

### Comparative Example 6

Comparative Example 6 was different from Example 1 in that YCl₃ was used as the raw material powder instead of ZrCl₄. The molar ratio of LiCl and YCl₃ was 3:1. A powder of Li_{3.0}YCl₆ was obtained by a mixing reaction of the raw material powder. Other conditions were the same as those of Example 1, and ion conductivity and X-ray diffraction were performed.

The ion conductivity of the solid electrolyte according to Comparative Example 6 was 2.3×10⁻⁴ S/cm.

The solid electrolyte according to Comparative Example 6 did not have a diffraction peak at each of the positions of 2θ=30.0°±0.5°, 2θ=32.0°±0.5°, and 2θ=34.4°±0.5°. Therefore, IB/IA and IC/lA could not be calculated.

### Example 32

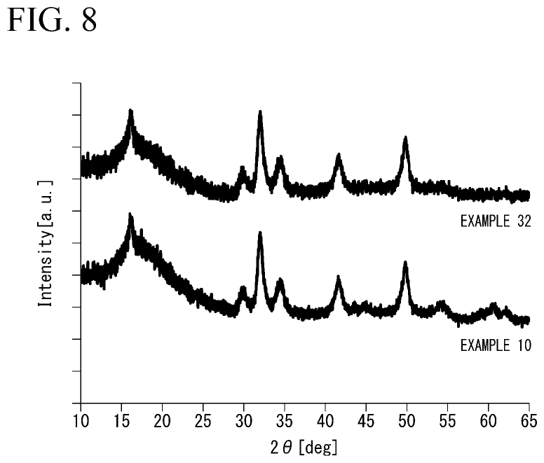

Example 32 was different from Example 10 in that the mechanochemical milling treatment time was 20 hours. Other conditions were the same as those of Example 10, and ion conductivity and X-ray diffraction were performed. FIG. 8 shows the X-ray diffraction results of Example 10 and Example 32. A powder of Li_{2.4}Zr_{0.9}Cl₆ was obtained by a mixing reaction of the raw material powder.

The ion conductivity of the solid electrolyte according to Example 32 was 5.7×10⁻⁴ S/cm.

The solid electrolyte according to Example 32 had a diffraction peak at each of the positions of 2θ=16.0°, 29.9°, 32.0°, 34.6°, 41.7°, and 49.8°.

The ratio IB/IA of the diffraction intensity IA of the diffraction peak at 2θ=32.0°±0.5° and the diffraction intensity IB of the diffraction peak at 2θ=34.4°±0.5° of the solid electrolyte according to Example 32 was 0.848.

Furthermore, the ratio IC/IA of the diffraction intensity IA of the diffraction peak at 2θ=32.0°±0.5° and the diffraction intensity IC of the diffraction peak at 2θ=30.0°±0.5° of the solid electrolyte described in Example 32 was 0.799.

[Creation of Solid Electrolyte Battery]

Each of solid electrolyte batteries having the solid electrolytes of Examples 1 to 32 and Comparative Examples 1 to 6 was produced by a method described below, and the discharge capacity was measured by a method described below.

First, weighing was performed so that lithium iron phosphate (LiFePO₄):each of the solid electrolytes of Example 1 to Example 32 or Comparative Examples 1 to 6:acetylene black=67:20:13 parts by weight, mixing was performed in an agate mortar, and the mixture was used as a positive electrode mixture.

Next, weighing was performed so that lithium titanium oxide (Li₄Ti₅O₁₂):each of the solid electrolytes of Example 1 to Example 32 or Comparative Examples 1 to 6:carbon black=68:20:12 parts by weight, mixing was performed in an agate mortar, and the mixture was used as a negative electrode mixture.

A resin holder, a lower punch (cum-negative electrode current collector), and an upper punch (cum-positive electrode current collector) were prepared.

The lower punch was inserted from under the resin holder, and 110 mg of the solid electrolytes of Example 1 to Example 32 or Comparative Examples 1 to 6 was put from above the resin holder. Next, the upper punch was inserted from above the solid electrolyte. This first unit was placed on a pressing machine to form a solid electrolyte layer at the pressure of 373 MPa. The first unit was taken out of the pressing machine to remove the upper punch.

Next, 10 mg of the positive electrode mixture was put on the solid electrolyte layer (upper punch side) in the resin holder, the upper punch was inserted thereon, a second unit was allowed to stand in the pressing machine to perform forming at a pressure of 373 MPa. Next, the second unit was taken out and turned upside down to remove the lower punch. 11 mg of the negative electrode mixture was put on the solid electrolyte layer (lower punch side), the lower punch was inserted thereon, a third unit was allowed to stand in the pressing machine to perform forming at the pressure of 373 MPa. In this manner, a battery element composed of the positive electrode current collector/the positive electrode/the solid electrolyte/the negative electrode/the negative electrode current collector was produced.

Thereafter, a disc made of stainless steel and a disc made of Teflon having a diameter of 50 mm and a thickness of 5 mm and having screw holes at four locations were prepared, and the battery element was set as follows. Loading was performed in the order of the stainless steel disc/the Teflon disc/the battery element/the Teflon disc/the stainless steel disc, and screws at four locations were tightened to produce a third unit. In addition, screws were inserted into screw holes on the side surfaces of the upper and lower punches as terminals for charging and discharging.

An A4 size aluminum laminated bag was prepared as an exterior body for enclosing the fourth unit 4. As external drawer terminals, aluminum foil (width 4 mm, length 40 mm, thickness 100 μm), in which polypropylene (PP) grafted with maleic acid anhydride was wrapped around, and nickel foil (width 4 mm, length 40 mm, thickness 100 μm) were heat-bonded to one side of an opening part of the aluminum laminated bag at intervals so as not to cause a short circuit. The fourth unit was inserted in the aluminum laminated bag to which the external drawer terminals were attached, and screws on the upper punch side surface and the aluminum terminal inside the exterior body, and screws on the lower punch side surface and the nickel terminal inside the exterior body were connected by a lead wire. Finally, an opening part of the exterior body was heat-sealed to obtain a solid electrolyte battery.

A charging and discharging test was performed in a constant-temperature tank at 25° C. Charging was performed at 0.1 C up to 4.2 V with a constant current and constant voltage (referred to as CCCV). Charging was performed until the current was 1/20 C, and then completed. Discharging was performed at 0.1 C up to 3.0 V. The results are shown in Table 1. The measurement results of Example 1 to Example 32 and Comparative Example 1 to Comparative Example 6 are summarized in Table 1.

TABLE 1

| | | Ion | Discharge | | |
|---|---|---|---|---|---|
| | | conductivity | capacity | | |
| | | (S/cm) | (μAh) | IC/IA | IB/IA |
| Example 1 | Li₂ZrCl₆ | 5.0E−04 | 608 | 0.151 | 0.195 |
| Comparative | Li₃YCl₆ | 2.3E−04 | 150 | — | — |
| Example 6 | | | | | |
| Example 2 | Li_{2.1}Al_{0.1}Zr_{0.9}Cl₆ | 8.5E−04 | 950 | 0.145 | 0.187 |
| Example 3 | Li_{2.2}Al_{0.2}Zr_{0.8}Cl₆ | 7.0E−04 | 804 | 0.285 | 0.347 |
| Example 4 | Li_{2.25}Al_{0.25}Zr_{0.75}Cl₆ | 5.8E−04 | 675 | 0.372 | 0.452 |
| Example 5 | Li_{2.3}Al_{0.3}Zr_{0.7}Cl₆ | 5.1E−04 | 610 | 0.460 | 0.549 |
| Example 6 | Li_{2.35}Al_{0.35}Zr_{0.65}Cl₆ | 4.5E−04 | 567 | 0.647 | 0.789 |
| Example 7 | Li_{2.4}Al_{0.4}Zr_{0.6}Cl₆ | 4.1E−04 | 510 | 1.044 | 1.290 |
| Example 8 | Li_{2.45}Al_{0.45}Zr_{0.55}Cl₆ | 3.9E−04 | 487 | 1.578 | 2.018 |
| Comparative | Li_{2.5}Al_{0.5}Zr_{0.5}Cl₆ | 3.4E−04 | 433 | 2.409 | 3.026 |
| Example 1 | | | | | |
| Example 9 | Li_{2.2}Zr_{0.95}Cl₆ | 4.5E−04 | 561 | 0.137 | 0.239 |
| Example 10 | Li_{2.4}Zr_{0.9}Cl₆ | 6.7E−04 | 780 | 0.342 | 0.520 |
| Example 11 | Li_{2.5}Zr_{0.875}Cl₆ | 7.1E−04 | 810 | 0.524 | 0.873 |
| Example 12 | Li_{2.6}Zr_{0.85}Cl₆ | 5.5E−04 | 650 | 0.962 | 1.709 |
| Example 13 | Li_{2.7}Zr_{0.825}Cl₆ | 4.4E−04 | 552 | 1.540 | 2.831 |
| Comparative | Li_{2.8}Zr_{0.8}Cl₆ | 3.6E−04 | 447 | 2.355 | 4.552 |
| Example 2 | | | | | |
| Example 14 | Li_{2.1}Y_{0.1}Zr_{0.9}Cl₆ | 5.8E−04 | 680 | 0.184 | 0.213 |
| Example 15 | Li_{2.2}Y_{0.2}Zr_{0.8}Cl₆ | 6.6E−04 | 760 | 0.245 | 0.318 |
| Example 16 | Li_{2.3}Y_{0.3}Zr_{0.7}Cl₆ | 6.3E−04 | 740 | 0.348 | 0.492 |
| Example 17 | Li_{2.4}Y_{0.4}Zr_{0.6}Cl₆ | 5.5E−04 | 650 | 0.557 | 0.841 |
| Example 18 | Li_{2.5}Y_{0.5}Zr_{0.5}Cl₆ | 4.4E−04 | 562 | 0.748 | 1.188 |
| Example 19 | Li_{2.6}Y_{0.6}Zr_{0.4}Cl₆ | 3.8E−04 | 457 | 1.344 | 2.218 |
| Comparative | Li_{2.7}Y_{0.7}Zr_{0.3}Cl₆ | 3.4E−04 | 423 | 2.071 | 3.533 |
| Example 3 | | | | | |
| Example 20 | Li_{1.9}Nb_{0.1}Zr_{0.9}Cl₆ | 4.4E−04 | 547 | 0.104 | 0.117 |
| Example 21 | Li_{1.8}Nb_{0.2}Zr_{0.8}Cl₆ | 5.0E−04 | 601 | 0.135 | 0.169 |
| Example 22 | Li_{1.7}Nb_{0.3}Zr_{0.7}Cl₆ | 5.4E−04 | 645 | 0.180 | 0.229 |
| Example 23 | Li_{1.6}Nb_{0.4}Zr_{0.6}Cl₆ | 5.9E−04 | 703 | 0.257 | 0.362 |
| Example 24 | Li_{1.5}Nb_{0.5}Zr_{0.5}Cl₆ | 5.4E−04 | 642 | 0.429 | 0.654 |
| Example 25 | Li_{1.4}Nb_{0.6}Zr_{0.4}Cl₆ | 4.4E−04 | 553 | 1.007 | 1.602 |
| Example 26 | Li_{1.3}Nb_{0.7}Zr_{0.3}Cl₆ | 3.8E−04 | 469 | 1.763 | 2.895 |
| Example 27 | Li_{2.1}Mg_{0.05}Zr_{0.95}Cl₆ | 5.5E−04 | 663 | 0.655 | 1.191 |
| Example 28 | Li_{2.2}Mg_{0.1}Zr_{0.9}Cl₆ | 6.0E−04 | 710 | 0.838 | 1.495 |
| Example 29 | Li_{2.3}Mg_{0.15}Zr_{0.85}Cl₆ | 4.5E−04 | 570 | 1.008 | 1.757 |
| Example 30 | Li_{2.4}Mg_{0.2}Zr_{0.8}Cl₆ | 4.3E−04 | 532 | 1.233 | 2.177 |
| Example 31 | Li_{2.6}Mg_{0.3}Zr_{0.7}Cl₆ | 3.9E−04 | 487 | 1.552 | 2.786 |
| Comparative | Li_{2.8}Mg_{0.4}Zr_{0.6}Cl₆ | 3.5E−04 | 446 | 2.053 | 3.725 |
| Example 4 | | | | | |
| Comparative | Li₃Mg_{0.5}Zr_{0.5}Cl₆ | 3.0E−04 | 408 | 2.919 | 5.320 |
| Example 5 | | | | | |
| Example 32 | Li_{2.4}Zr_{0.9}Cl₆ | 5.70E−04 | 668 | 0.799 | 0.848 |

As shown in Table 1, all of the solid electrolytes of Example 1 to Example 32 had sufficiently high ion conductivity. Furthermore, all of the solid electrolyte batteries having the solid electrolytes of Example 1 to Example 32 had a sufficiently large discharge capacity.

(Discussion)

When Example 1 to Example 32 are compared with Comparative Examples 1 to 6, it was found that ion conductivity higher than 3.5×10⁻⁴ S/cm was shown at the vicinity of room temperature in Example 1 to Example 32.

It was found that the solid electrolytes according to Example 1 to Example 32 exhibit excellent ion conductivity than the solid electrolytes according to Comparative Example 1 to Comparative Example 6. It was thought that, in Examples 1 to 32 and Comparative Examples 1 to 5, the compound containing the alkali metal element, the tetravalent metal element, and the halogen element as main elements was used, and thereby binding of the alkali metal by the halogen element was weakened, which made the movable ions to move easily and improved ion conductivity, as compared to Comparative Example 6.

Furthermore, in the examples in which the values of IB/IA and IC/IA were within a predetermined range, ion conductivity was high. Accordingly, as shown in FIG. 4, when the solid electrolyte had a diffraction peak at each of the positions of 2θ=30.0°±0.5°, 2θ=32.0°±0.5°, and 2θ=34.4°±0.5°, and a diffraction peak intensity at 2θ=32.0°±0.5° was larger than the other diffraction peak intensities, ion conductivity was improved. It is thought that ion conductivity was improved because the conduction path of the movable ions was secured by adopting such a characteristic structure.

### REFERENCE SIGNS LIST

1 Positive electrode, 1A Positive electrode current collector, 1B Positive electrode active material layer, 2 Negative electrode, 2A Negative electrode current collector, 2B Negative electrode active material layer, 3 Solid electrolyte layer, 10 Solid electrolyte battery

1. A solid electrolyte comprising:
a compound that contains an alkali metal element, a tetravalent metal element, and a halogen element as main elements,
wherein the compound has diffraction peaks at positions of 2θ=32.0°±0.5° and 2θ=34.4°±0.5° for a wavelength of CuKα rays, and a ratio IB/IA of a diffraction intensity IB of a peak with a strongest diffraction intensity at 2θ=34.4°±0.5° to a diffraction intensity IA of a peak with a strongest diffraction intensity at 2θ=32.0°±0.5° satisfies 0<IB/IA≤3.

2. A solid electrolyte comprising:
a compound that contains an alkali metal element, a tetravalent metal element, and a halogen element as main elements,
wherein the compound has diffraction peaks at positions of 2θ=32.0°±0.5° and 2θ=30.0°±0.5° for a wavelength of CuKα rays, and a ratio IC/IA of a diffraction intensity IC of a peak with a strongest diffraction intensity at 2θ=30.0°±0.5° to a diffraction intensity IA of a peak with a strongest diffraction intensity at 2θ=32.0°±0.5° satisfies 0<IC/IA≤2.

3. The solid electrolyte according to claim 1,
wherein the compound has a diffraction peak at each of the following positions for the wavelength of CuKα rays,
2θ=16.1°±0.5°,
2θ=41.7°±0.5°, and
2θ=49.9°±0.5°.

4. The solid electrolyte according to claim 1,
wherein the compound has a diffraction peak at each of the following positions for the wavelength of CuKα rays,
2θ=43.7°±0.5°,
2θ=45.0°±0.5°,
2θ=54.2°±0.5°,
2θ=59.1°±0.5°,
2θ=60.5°±0.5°, and
2θ=62.2°±0.5°.

5. The solid electrolyte according to claim 1,
wherein the compound has a diffraction peak at each of the following positions with respect to the wavelength of CuKα rays,
2θ=30.0°±0.5°, and
2θ=34.4°±0.5°.

6. The solid electrolyte according to claim 1, wherein the tetravalent metal element is one or more elements selected from the group consisting of Zr, Hf, Ti, Sn, and Ge.

7. The solid electrolyte according to claim 1,
wherein the compound is represented by a composition formula Li₂₊ₐM_{b}Zr_{1+c}Cl_{6+d},
−1.5≤a≤1.5, 0≤b≤1.5, −0.7≤c ≤0.2, and −0.2≤d≤0.2 is satisfied, and
M is one or more elements selected from Al, Y, Ca, Nb, and Mg.

8. A solid electrolyte layer comprising the solid electrolyte according to claim 1.

9. A solid electrolyte battery comprising:
a positive electrode;
a negative electrode; and
a solid electrolyte layer sandwiched between the positive electrode and the negative electrode,
wherein at least one of the positive electrode, the negative electrode, and the solid electrolyte layer contains the solid electrolyte according to claim 1.

10. A solid electrolyte battery comprising:
a positive electrode;
a negative electrode; and
a solid electrolyte layer sandwiched between the positive electrode and the negative electrode,
wherein the solid electrolyte layer contains the solid electrolyte according to claim 1.

11. The solid electrolyte according to claim 2,
wherein the compound has a diffraction peak at each of the following positions for the wavelength of CuKα rays,
2θ=16.1°±0.5°,
2θ=41.7°±0.5°, and
2θ=49.9°±0.5°.

12. The solid electrolyte according to claim 2,
wherein the compound has a diffraction peak at each of the following positions for the wavelength of CuKα rays,
2θ=43.7°±0.5°,
2θ=45.0°±0.5°,
2θ=54.2°±0.5°,
2θ=59.1°±0.5°,
2θ=60.5°±0.5°, and
2θ=62.2°±0.5°.

13. The solid electrolyte according to claim 2,
wherein the compound has a diffraction peak at each of the following positions for the wavelength of CuKα rays,
2θ=30.0°±0.5°, and
2θ=34.4°±0.5°.

14. The solid electrolyte according to claim 2, wherein the tetravalent metal element is one or more elements selected from the group consisting of Zr, Hf, Ti, Sn, and Ge.

15. The solid electrolyte according to claim 2,
wherein the compound is represented by a composition formula Li₂₊ₐM_{b}Zr_{1+c}Cl_{6+d},
−1.5≤a≤1.5, 0≤b≤1.5, −0.7≤c≤0.2, and −0.2≤d≤0.2 is satisfied, and
M is one or more elements selected from Al, Y, Ca, Nb, and Mg.

16. A solid electrolyte layer comprising the solid electrolyte according to claim 2.

17. A solid electrolyte battery comprising:
a positive electrode;
a negative electrode; and
a solid electrolyte layer sandwiched between the positive electrode and the negative electrode,
wherein at least one of the positive electrode, the negative electrode, and the solid electrolyte layer contains the solid electrolyte according to claim 2.

18. A solid electrolyte battery comprising:
a positive electrode;
a negative electrode; and
a solid electrolyte layer sandwiched between the positive electrode and the negative electrode,
wherein the solid electrolyte layer contains the solid electrolyte according to claim 2.
